(19) United States
(12) Patent Application Publication
(10) Pub. No.: US 2007/0014561 A1
(43) Pub. Date: Jan. 18, 2007

(54) Lens module and electrical apparatus thereof

(75) Inventors: Yi-Ming Lee, Taipei (TW); Yung-Chuan Chen, Taipei (TW); Yen-Kuang Chen, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTeK Computer Inc.

(21) Appl. No.: 11/414,946

(22) Filed: May 1, 2006

(30) Foreign Application Priority Data
Jul. 12, 2005 (TW) 94123647

(51) Int. Cl. G03B 3/10

(52) U.S. Cl. 396/133

(57) ABSTRACT

A lens module includes a driving apparatus, a rotary device, and a lens assembly. The rotary device includes a contact portion having a continuous ramp and is rotated by the driving apparatus. The lens assembly includes a guide portion which contacts the contact portion and a lens moving along with the guide portion. A rotation of the rotary device is driven by the driving apparatus and a displacement of the lens assembly is promoted by the rotation of the rotary device via the guide portion so that focus is achieved.

### RELATED APPLICATIONS

The present application is based on, and claims priority from, Taiwan Application Serial Number 94123647, filed Jul. 12, 2005, the disclosure of which is hereby incorporated by reference herein in its entirety.

### BACKGROUND

1. Field of Invention

The present invention relates to a lens module. More particularly, the present invention relates to a lens module driven by a motor.

2. Description of Related Art

As electronic technology improves, more and more analog circuits are replaced by digital circuits in electronic devices. Digital cameras are one group of these recently developed electronic devices having digital circuitry, most of which provide an auto-focus function instead of a conventional manual one.

A conventional lens module mainly includes a motor, a worm drive mechanism, a rotary device, a lens assembly, an image sensor and a photo sensor. The motor cooperates with the worm drive mechanism to drive the lens assembly and the photo sensor is for defining a focal reference point.

FIG. 1A shows a schematic plan view of a conventional lens module. A motor 100 drives a worm drive mechanism 120 to rotate, which in turn drives a rotary device 122 to rotate. The lens assembly 130 includes an extended portion 132 for contacting the rotary device 122 to move the lens assembly 130 in response to the rotation of the rotary device 122. Thus, auto focussing is achieved by the rotational adjustment.

The lens assembly 130 also includes an interrupt portion 134. A reference point, which is a start point in an auto focussing procedure, is set up when rays delivered from the photo sensor 150 are interrupted by the interrupt portion 134. Through a control system, the lens assembly 130 moves on the top surface of the rotary device 122 within a predefined distance from the reference point until an image sensor senses an image to be focused.

However, in such a conventional design, the interrupter sensor is required and the whole electronic apparatus inevitably consumes extra power. Further, without proper isolation between the interrupter sensor and the image sensor, flare or electrical discharge problem is possibly generated in the image sensor due to interference from the photo sensor.

Reference is also made to FIG. 1B, which is a schematic view of a rotary device of the conventional lens module. The convention rotary device includes a stepped structure 190, which presents a potential problem: during improper use, unstable signal operation or other device error, the lens assembly moves across and falls off the peak of the stepped structure, resulting in damage to the lens.

For the foregoing reasons, there is a need for a structure that conserves more space, consumes less power, and prevents image interference.

### SUMMARY

It is therefore an objective of the present invention to provide a lens module for avoiding possible damage to a lens due to a stepped rotary device.

In accordance with the foregoing and other objectives of the present invention, a lens module is provided which includes a driving apparatus, a rotary device and a lens assembly. A contact portion at the top of the rotary device rotated by the driving apparatus is a continuous, non-stepped ramp.

The lens assembly includes a guide portion coupled with the contact portion and a lens moving along with the guide portion. The lens assembly is driven to move via the contact portion. The driving apparatus may include a motor and a transmission member connected thereto. The motor drives the transmission member and the rotary device to rotate; and the lens assembly is displaced by the rotation of the rotary device via the guide portion to implement focussing.

According to a preferred embodiment, a combination of the transmission member and the rotary device is a worm gear system. During focussing, the motor drives a worm to rotate the worm gear structure of the rotary device. Because the guide portion contacts the rotary device and the contact position changes during rotation of the rotary device, the lens assembly keeps moving to find optimum resolution. Moreover, a proper cooperation of the guide portion and the rotary device for a full 360-degree circle is available. Therefore, a focus search can start from any location at which the lens assembly resides, rather than the conventional way that requires searching for a start point.

In conclusion, the lens module of the invention employs a continuous, non-stepped ramp to allow a full-circle rotation and an arbitrary starting rotation direction, thus not requiring searching for a start point before focussing. The present invention even ensures the safety of the lens, preventing the guide portion from moving across the peak of the rotary device due to an unexpected operational error to damage the lens assembly as in the conventional case.

Further, without a photo sensor, an image sensor is prevented from interference by infrared rays; and benefits of the electrical apparatus using less space, costing less and consuming less power are also obtained. Applied in small-scale devices such as a camera, the present invention enables products of lower cost and higher reliability.

It is to be understood that both the foregoing general description and the following detailed description are by examples and are intended to provide further explanation of the invention as claimed.

### BRIEF DESCRIPTION OF THE DRAWINGS

These and other features, aspects and advantages of the present invention are better understood with regard to the following description, appended claims and accompanying drawings, wherein:

FIG. 1A is a schematic plan view of a conventional lens module;

FIG. 1B is a schematic view of a rotary device of the conventional lens module;

FIG. 2A is a schematic plan view of a lens module in accordance with a preferred embodiment of the present invention;

FIG. 2B is a schematic view of a rotary device of the lens module in accordance with a preferred embodiment of the present invention;

FIG. 3A is a perspective view of the lens module in accordance with a preferred embodiment of the present invention; and

FIG. 3B is a schematic view of engagement of teeth in FIG. 3A.

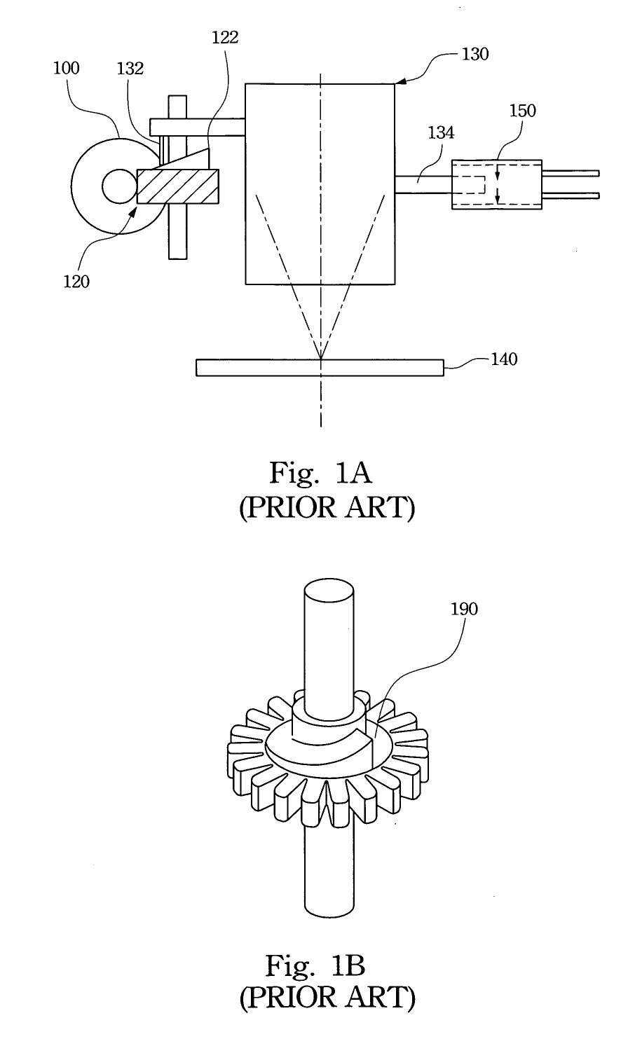

### DESCRIPTION OF THE PREFERRED EMBODIMENTS

The present invention discloses a lens module which performs an auto-focus function without a photo sensor by employing a non-stepped rotary device. Reference is now made in detail to the present preferred embodiments of the invention, examples of which are illustrated in the accompanying drawings. Wherever possible, the same reference numbers are used in the drawings and the description to refer to the same or like portions.

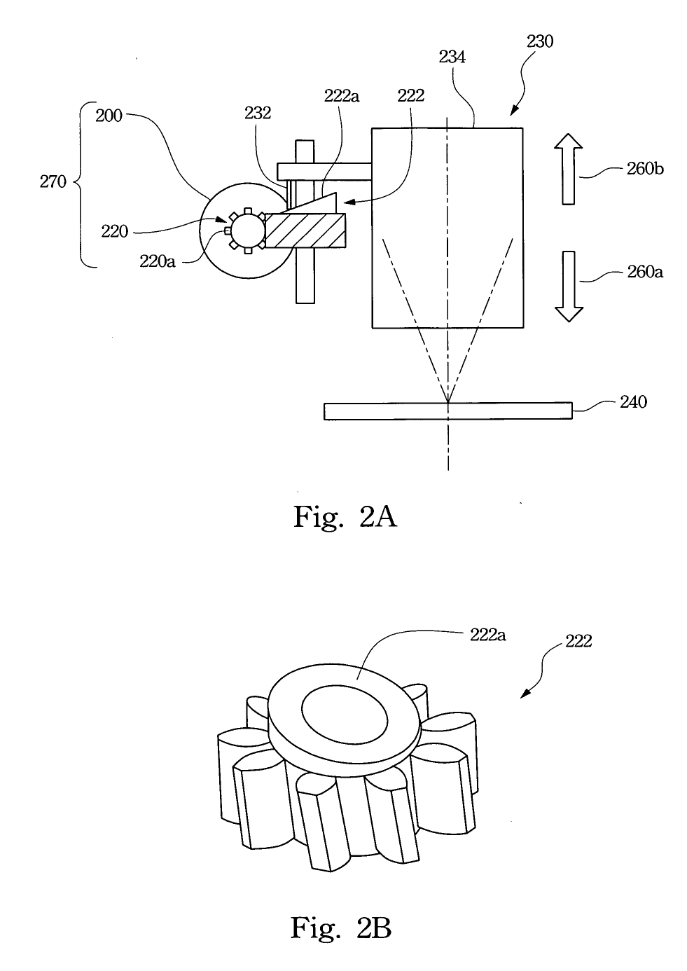

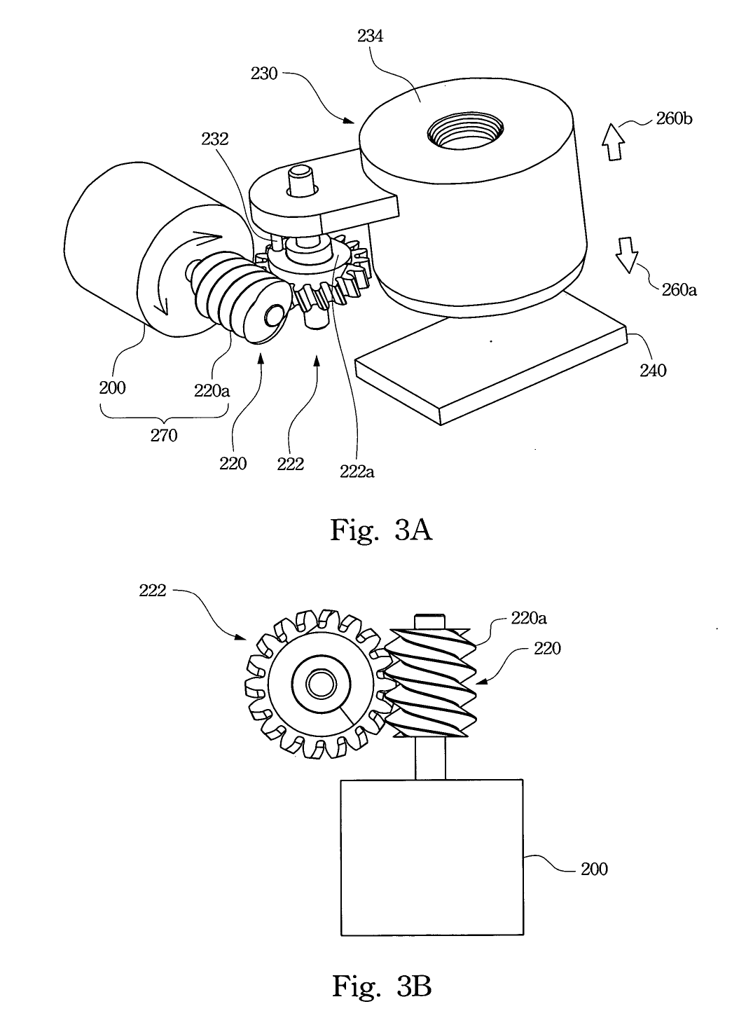

FIG. 2A illustrates a lens module in accordance with a preferred embodiment of the present invention, and FIG. 3A is a perspective view of the lens module. The lens module includes a driving apparatus 270, a rotary device 222 and a lens assembly 230. The rotary device 222 is driven to rotate by the driving apparatus 270 and has a contact portion 222a which is a continuously ramped surface of the rotary device 222. The lens assembly 230 includes a lens 234 and a guide portion 232. The lens 234 moves following the movement of the guide portion 232 in contact with the contact portion 222a. Therefore, movement of the lens assembly 230 and focus motion are motivated by a rotation of the contact portion 222a.

In a preferred embodiment, the lens module is installed on a handheld phone or a camera. The driving apparatus 270 includes a motor 200 and a transmission member 220. The motor 220 drives the transmission member 220 to rotate, and the transmission member 220 simultaneously rotates the rotary device 222. The motor 200 can be a servo motor for speed control.

At least a portion of the transmission member 220 has a plurality of teeth 220a. A transmission gear system can be selected as a combination of the transmission member 220 and the rotary device 222, such as a worm gear system with the transmission member 220 acting as a worm with a plurality of teeth 220a. The contact portion 222a is an annular, continuous ramp.

The motor 200 is connected with the transmission member 220, and drives the teeth 220a and the rotary device 222 to rotate. During focussing, the motor 200 operates to drive the transmission member 220 to rotate, which also results in the rotary device 222 to rotate.

Since the guide portion 232 of the lens assembly 230 contacts the contact portion 222a of the rotary device 222, the contact position changes as the rotary device 222 rotates, consequently displacing the lens assembly 230 in a first direction displacement 260a. When the rotation direction of the motor 200 is reversed, the lens assembly 230 moves in an opposite direction, second direction displacement 260b. An image sensor 240 receives an optical signal transmitted through the lens assembly 230 to implement a focus search, and when the best resolution is found, the motor 200 is stopped. Therefore, auto focus is achieved.

The guide portion 232 is capable of rotating on the rotary device 222 for a full 360-degree circle due to a non-stepped and continuously ramped structure of the rotary device 222, and both keep contact even after several rotations. By changing the rotation direction of the motor 200, the rotary device 222 can rotate in an opposite rotation direction to implement the focus search. It also allows that the focus search starts from any last location at which the lens assembly stopped and in any rotation direction without the requirement of searching for a specific start point.

Reference is now made to FIG. 2B, which illustrates a schematic view of a rotary device in accordance with a preferred embodiment of the present invention. The figure shows that the rotary device 222 is a peripherally continuous and non-stepped structure; that is, the contact portion 222a has a continuous surface. In the embodiment, preferably, the rotary device 222 is symmetrical in geometry so that the focus search is more efficient.

FIG. 3B is a schematic view of engagement of teeth in FIG. 3A. Engagement between teeth 220a of the transmission member 220 and the rotary device 222 is clearly shown in the figure.

The present invention has the following advantage. With a continuously ramped design for the rotary device, the lens module is able to implement a focus search for a full rotation. The lens assembly can start the focus search from any location without a conventional positioning step, so that a positioning apparatus like a photo sensor is not required. Not only the space in the whole module can be saved, but the cost of the module can be reduced.

Moreover, a lack of power consumption of a positioning apparatus is a further great advantage, especially for small-scale electronic apparatuses. Exclusion of the photo sensor prevents the image sensor from interference by infrared rays. The capability of a full-circle cooperative motion between the guide portion and the rotary device also eliminates a potential problem of damage to the lens assembly due to falling from the peak of a conventional rotary device having a stepped structure.

It should be noted that the transmission member is not limited to the structure and shape described in the embodiment. Other types of the transmission mechanism within the spirit and scope of the present invention can be envisioned by a person skilled in the art.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A lens module, comprising:
a driving apparatus;
a rotary device rotated by the driving apparatus and having a contact portion, wherein the contact portion is located on a top surface of the rotary device, rotates along with the rotary device, and has a continuous ramp; and
a lens assembly having a lens and a guide portion,
wherein the guide portion contacts the contact portion and the lens moves along with the guide portion so that the lens assembly is driven to move by the contact portion.

2. The lens module of claim 1, wherein the driving apparatus comprises a motor and a transmission member, wherein the transmission member is rotated by the motor to drive the rotary device.

3. The lens module of claim 2, wherein the transmission member is connected with the motor and at least a portion of the transmission portion includes a plurality of teeth engaged with the rotary device.

4. The lens module of claim 2, wherein the transmission member is a worm and the rotary device is a worm gear.

5. The lens module of claim 1, wherein the contact portion is an annular, continuously ramped surface.

6. An electrical apparatus, comprising:
a driving apparatus;
a rotary device rotated by the driving apparatus and having a contact portion wherein the contact portion is located on a top surface of the rotary device, rotates along with the rotary device, and has a continuous ramp;
a lens assembly having a lens and a guide portion, wherein the guide portion contacts the contact portion and the lens moves along with the guide portion so that the guide portion is driven to move by the contact portion; and
an image sensor for receiving an optical signal transmitted through the lens assembly,
wherein a rotation of the rotary device induces a displacement of the lens assembly via the guide portion.

7. The electrical apparatus of claim 6, wherein the driving apparatus comprises a motor and a transmission member, wherein the transmission member is rotated by the motor to drive the rotary device.

8. The electrical apparatus of claim 7, wherein the transmission member is connected with the motor and at least a portion of the transmission portion includes a plurality of teeth engaged with the rotary device.

9. The electrical apparatus of claim 7, wherein the transmission member is a worm and the rotary device is a worm gear.

10. The electrical apparatus of claim 6, wherein the contact portion is an annular, continuously ramped surface.
